(19) United States
(12) Patent Application Publication
(10) Pub. No.: US 2026/0284620 A1
(43) Pub. Date: Sep. 24, 2026

(54) METHOD FOR OPERATING LOCK HOPPER AND SOLID MOVEMENT DEVICE

(71) Applicant: MITSUBISHI HEAVY INDUSTRIES, LTD., Tokyo (JP)

(72) Inventors: Makoto TOBO, Tokyo (JP); Toshizumi YOSHIMOTO, Tokyo (JP); Setsuo OMOTO, Takasago City (JP); Takamasa OMIYA, Tokyo (JP)

(21) Appl. No.: 19/490,024

(22) PCT Filed: Jun. 10, 2024
(86) PCT No.: PCT/JP2024/021084

§ 371 Date: Dec. 4, 2025

(30) Foreign Application Priority Data
Jun. 13, 2023 (JP) 2023-097081

(51) Int. Cl. B01J 4/00; B01J 6/00; C01B 3/24; C01B 32/05

(52) U.S. Cl. CPC B01J 4/007; B01J 6/008; C01B 3/24; C01B 32/05; B01J 2204/005; C01B 2203/0272; C01B 2203/1241; C01B 2203/1609

(57) ABSTRACT

The solid movement step is a step of moving a solid from one of the inside of a combustible gas production system and the outside of the combustible gas production system to the other one by introducing a solid into a lock hopper or discharging the solid from the lock hopper. The combustible gas production system is a system for generating a combustible gas. The non-combustible gas introduction step is a step of introducing a non-combustible gas into a lock hopper from a path different from an introduction port for the solid and a discharge port for the solid. The discharge step is a step of discharging, from the lock hopper, a gas in the lock hopper using a path different from an introduction port for the solid and a discharge port for the solid.

### TECHNICAL FIELD

The present disclosure relates to a method for operating a lock hopper and a solid movement device.

### BACKGROUND ART

For example, Patent Document 1 below describes a precipitator that removes a solid material produced when a combustible gas is produced. This precipitator includes a filter device that removes a solid material from the combustible gas. The filter device is connected to a lock hopper via a receiving valve. During the period in which the receiving valve is in an open state, the solid material accumulates from the filter to the lock hopper. When the solid material accumulated in the lock hopper reaches a predetermined amount, the receiving valve is closed. Then, nitrogen as a non-combustible gas is supplied into the lock hopper. Thereafter, the solid material is discharged from the lock hopper.

### CITATION LIST

### Patent Document

Patent Document 1: JP 2017-110166 A

### SUMMARY OF INVENTION

### Technical Problem

The above device has a risk that the nitrogen concentration in a production path of a combustible gas increases due to nitrogen supplied into the lock hopper. When a solid is released from the lock hopper into a space open to the atmosphere, there is a risk that a combustible gas flows out into the atmosphere.

### Solution to Problem

One aspect of the present disclosure provides a method for operating a lock hopper including a solid movement step. The solid movement step is a step of moving a solid from either one of an inside of a combustible gas production system and an outside of the combustible gas production system to the other one by introducing a solid into a lock hopper or discharging the solid from the lock hopper. The combustible gas production system is a system that produces a combustible gas. The method for operating a lock hopper includes a non-combustible gas introduction step and a discharge step. The non-combustible gas introduction step is a step of introducing a non-combustible gas into a lock hopper from a path different from an introduction port for the solid and a discharge port for the solid. The discharge step is a step of discharging a gas in the lock hopper from the lock hopper by using a path different from an introduction port for the solid and a discharge port for the solid.

Another aspect of the present disclosure provides a solid movement device including a lock hopper utilized for moving a solid from either one of an inside of a combustible gas production system and an outside of the combustible gas production system to the other one. The combustible gas production system is a system that produces a combustible gas. The lock hopper is connected to a discharge path and a non-combustible gas supply path separately from an introduction port for the solid and a discharge port for the solid. The combustible gas discharge path is a path through which a gas containing a combustible gas is discharged from the lock hopper. The non-combustible gas supply path is a path for supplying a non-combustible gas to the lock hopper.

### BRIEF DESCRIPTION OF DRAWINGS

FIG. 1 is a view illustrating a configuration of a fuel gas production system according to a first embodiment.

FIG. 2 is a view illustrating one step of a carbon discharge process according to the embodiment.

FIG. 3 is a view illustrating one step of the carbon discharge process according to the embodiment.

FIG. 4 is a view illustrating one step of the carbon discharge process according to the embodiment.

FIG. 5 is a view illustrating one step of the carbon discharge process according to the embodiment.

FIG. 6 is a view illustrating one step of the carbon discharge process according to the embodiment.

FIG. 7 is a view illustrating one step of the carbon discharge process according to the embodiment.

FIG. 8 is a view illustrating one step of the carbon discharge process according to the embodiment.

FIG. 9 is a view illustrating one step of the carbon discharge process according to the embodiment.

FIG. 10 is a view illustrating one step of a catalyst supply process according to the embodiment.

FIG. 11 is a view illustrating one step of the catalyst supply process according to the embodiment.

FIG. 12 is a view illustrating one step of the catalyst supply process according to the embodiment.

FIG. 13 is a view illustrating one step of the catalyst supply process according to the embodiment.

FIG. 14 is a view illustrating one step of the catalyst supply process according to the embodiment.

FIG. 15 is a view illustrating one step of the catalyst supply process according to the embodiment.

FIG. 16 is a view illustrating one step of the catalyst supply process according to the embodiment.

FIG. 17 is a view illustrating one step of the catalyst supply process according to the embodiment.

FIG. 18 is a view illustrating one step of the catalyst supply process according to the embodiment.

FIG. 19 is a view illustrating a configuration of a fuel gas production system according to a second embodiment.

FIG. 20 is a view illustrating a configuration of a fuel gas production system according to a third embodiment.

FIG. 21 is a view illustrating one step of a carbon discharge process according to a fourth embodiment.

FIG. 22 is a view illustrating one step of the catalyst supply process according to the embodiment.

### DESCRIPTION OF EMBODIMENTS

### First Embodiment

Hereinafter, the first embodiment will be described with reference to the drawings.

### “System Configuration”

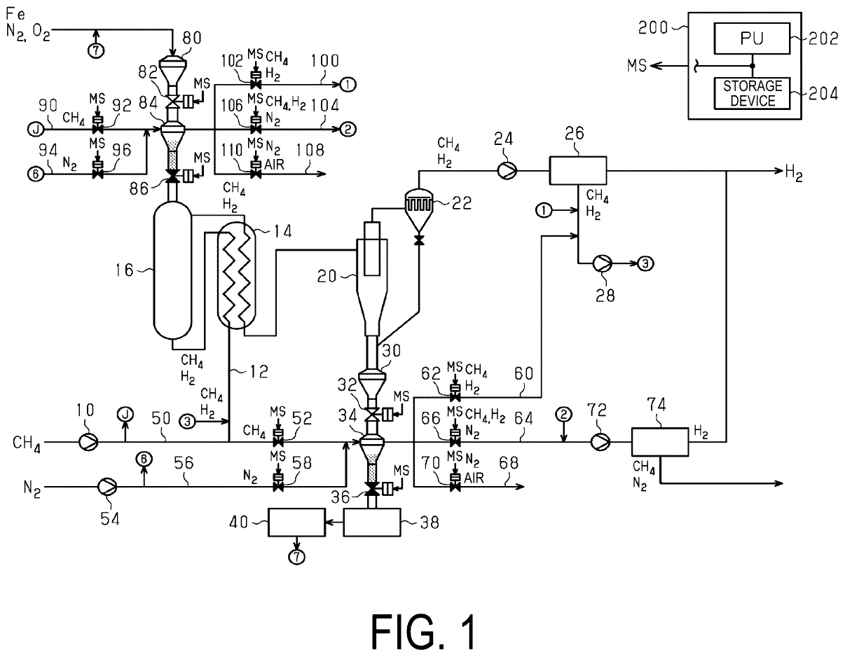

FIG. 1 illustrates the configuration of the production system of the combustible gas according to the present embodiment. The system illustrated in FIG. 1 is a system that produces hydrogen using methane as a feedstock. Hydrogen may be a fuel of a gas turbine for power generation as an example.

As illustrated in FIG. 1, methane to be supplied to the system is pressurized by a compressor 10 to be supplied to a combustible gas supply path 50. A feedstock gas path 12 is connected to the combustible gas supply path 50. Methane in the feedstock gas path 12 is heated by a heat exchanger 14 and then supplied to a reactor 16. The reactor 16 is a device that decomposes methane into hydrogen and carbon by thermal decomposition. The reactor 16 is provided with a catalyst. The catalyst is, for example, iron. In the reactor 16, the state of the catalyst is, for example, fluidized bed. In the reactor 16, the temperature of the methane and the catalyst to be reacted is, for example, 750 to 900° C. The pressure in the reactor 16 is higher than the atmospheric pressure. The pressure in the reactor 16 may be, for example, from several ata to several tens of ata.

The hydrogen and carbon produced by thermal decomposition in the reactor 16 and the methane in the reactor 16 flow into the heat exchanger 14. A mixture gas of the methane and hydrogen flowing out of the heat exchanger 14 and carbon flow into a cyclone 20. The cyclone 20 is a centrifugal separation device that separates carbon from a mixture of a mixture gas and carbon. The cyclone 20 is connected to a filter device 22. This is a device that captures carbon that could not be separated by the cyclone 20. The mixture gas flowing out of the filter device 22 is compressed by a compressor 24 and then supplied to a hydrogen refiner 26. The hydrogen refiner 26 is, for example, pressure swing adsorption (PSA). The hydrogen extracted from the mixture gas by the hydrogen refiner 26 is hydrogen to be produced by the present system.

The methane separated by the hydrogen refiner 26 is compressed by an off-gas compressor 28 and then returned to the feedstock gas path 12. Note that since hydrogen is utilized when methane is separated in the hydrogen refiner 26, hydrogen flows into the off-gas compressor 28 in addition to methane.

The carbon separated from the mixture gas by the cyclone 20 and the filter device 22 flows into a supply hopper 30. The supply hopper 30 is connected to a lock hopper 34 via an introduction valve 32. The lock hopper 34 discharges carbon to a storage 38 via a discharge valve 36. The storage 38 is open to the atmosphere.

The combustible gas supply path 50 is connected to the lock hopper 34 via a combustible gas supply valve 52. A non-combustible gas supply path 56 is connected to the lock hopper 34 via a non-combustible gas supply valve 58. Nitrogen to be supplied to the system is pressurized by a compressor 54 to be supplied to the non-combustible gas supply path 56.

The lock hopper 34 is connected to a produced gas path 60 via a produced gas valve 62. The produced gas path 60 is connected to the off-gas compressor 28. The lock hopper 34 is connected to a mixed gas path 64 via a mixed gas valve 66. A mixture gas of methane, hydrogen, and nitrogen is discharged from the lock hopper 34 to the mixed gas path 64. This mixture gas is pressurized by a mixed gas compressor 72 to be supplied to a hydrogen refiner 74. The hydrogen refiner 74 is, for example, pressure swing adsorption (PSA). The hydrogen extracted from the mixture gas by the hydrogen refiner 74 is also hydrogen to be produced by the present system. Note that the mixer of methane and nitrogen separated from the mixture gas by the hydrogen refiner 74 may be removed, for example, by combustion.

The lock hopper 34 is connected to a non-combustible gas discharge path 68 via a non-combustible gas discharge valve 70. The non-combustible gas discharge path 68 is open to the atmosphere.

Strictly speaking, the solid to be discharged to the storage 38 includes not only carbon but also a compound of iron and carbon, in which iron is a catalyst. A reproduction device 40 extracts iron from this compound. The iron extracted by the reproduction device 40 joins with iron to be newly supplied to the system to be supplied to a supply hopper 80.

The supply hopper 80 is connected to a lock hopper 84 via an introduction valve 82. The lock hopper 84 is connected to the reactor 16 via a discharge valve 86.

A combustible gas supply path 90 is connected to the lock hopper 84 via a combustible gas supply valve 92. The combustible gas supply path 90 is connected to the combustible gas supply path 50. The lock hopper 84 is connected to a non-combustible gas supply path 94 via a non-combustible gas supply valve 96. The non-combustible gas supply path 94 is supplied with the nitrogen compressed by the compressor 54.

The lock hopper 84 is connected to a produced gas path 100 via a produced gas valve 102. The produced gas path 100 is connected to the off-gas compressor 28. The lock hopper 84 is connected to a mixed gas path 104 via a mixed gas valve 106. A mixture gas of methane, hydrogen, and nitrogen is discharged from the lock hopper 84 to the mixed gas path 104. This mixture gas is pressurized by the mixed gas compressor 72 to be supplied to the hydrogen refiner 74. The lock hopper 84 is connected to a non-combustible gas discharge path 108 via a non-combustible gas discharge valve 110. The non-combustible gas discharge path 108 is open to the atmosphere.

A control device 200 takes the above-described production system as a control target. The control device 200 operates the introduction valve 32, the discharge valve 36, the combustible gas supply valve 52, the non-combustible gas supply valve 58, the produced gas valve 62, the mixed gas valve 66, and the non-combustible gas discharge valve 70. The control device 200 operates the introduction valve 82, the discharge valve 86, the combustible gas supply valve 92, the non-combustible gas supply valve 96, the produced gas valve 102, the mixed gas valve 106, and the non-combustible gas discharge valve 110.

The control device 200 includes a PU 202 and a storage device 204. The PU 202 is a software processing device including at least one of a CPU, a GPU, and TPU. The storage device 204 stores a program including a command to open/close the 14 valves described above. This program is executed by the PU 202, whereby opening/closing control of the 14 valves described above is realized.

### “Carbon Discharge Process”

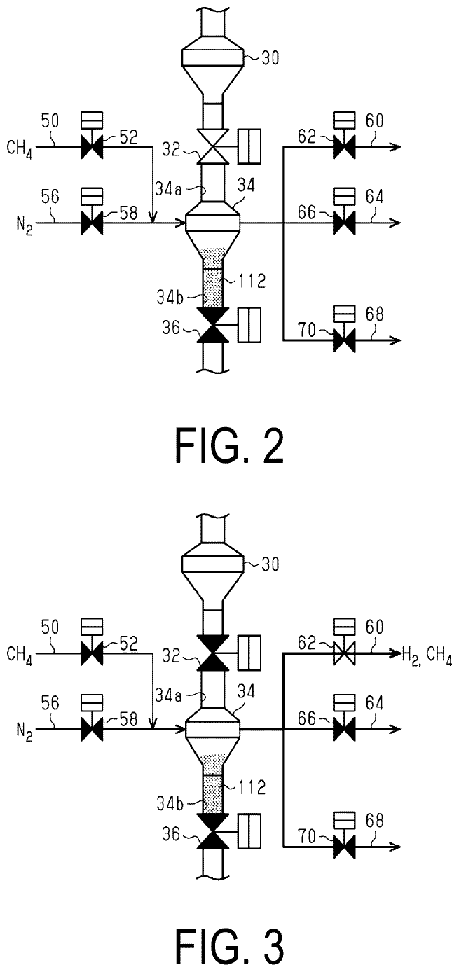

As described above, the pressure in the reactor 16 is higher than atmospheric pressure. By this, the pressure in the cyclone 20 and the pressure in the filter device 22 are also higher than the atmospheric pressure. On the other hand, the storage 38 is open to the atmosphere. Therefore, the lock hopper 34 is utilized in order to discharge carbon from a pressurized system including the reactor 16 while maintaining the pressure in the pressurized system. Hereinafter, a discharge process of carbon using the lock hopper 34 will be described with reference to FIGS. 2 to 9. Note that the figure numbers in FIGS. 2 to 9 follow the time series of the step.

FIG. 2 illustrates a state in which carbon 112 that is a solid is accumulated in the lock hopper 34. In FIG. 2, an open/closed states of the introduction valve 32, the discharge valve 36, the combustible gas supply valve 52, the non-combustible gas supply valve 58, the produced gas valve 62, the mixed gas valve 66, and the non-combustible gas discharge valve 70 are color-coded. That is, the black valve indicates being in a closed state, while the white valve indicates being in an open state. As illustrated in FIG. 2, in a step of accumulating the carbon 112 in the lock hopper 34, only the introduction valve 32 of the seven valves described above is in the open state. By this, the carbon 112 flowed into the supply hopper 30 flows into the lock hopper 34. Note that the mixture gas of hydrogen and methane flowing out of the reactor 16 also flows into the lock hopper 34.

FIG. 3 illustrates a step of pressure-reducing the inside of the lock hopper 34. This step is a step executed on the condition of being brought into the state illustrated in FIG. 2. In this step, only the produced gas valve 62 of the seven valves is brought into the open state by the PU 202. By this, the produced gas that is a mixture gas of hydrogen and methane in the lock hopper 34 flows out to the produced gas path 60.

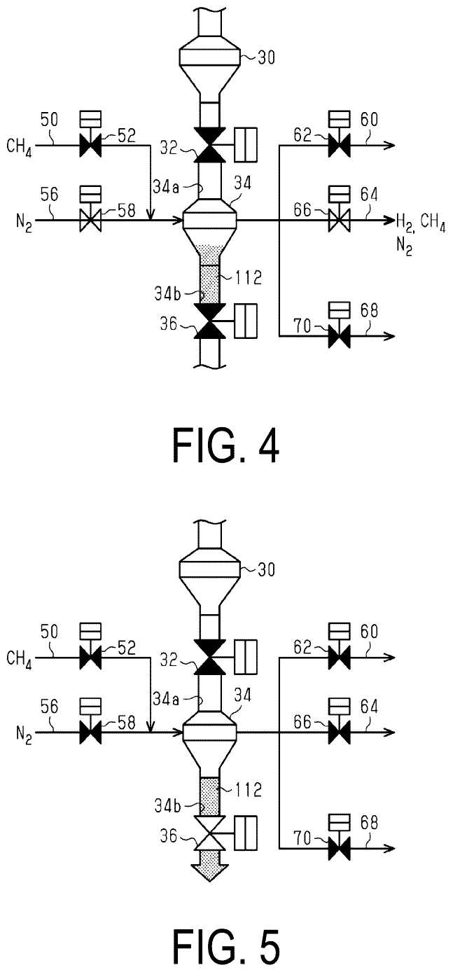

FIG. 4 illustrates a step of purging the produced gas from the lock hopper 34. This step is a step following the step illustrated in FIG. 3. In this step, only the non-combustible gas supply valve 58 and the mixed gas valve 66 of the seven valves are brought into the open state by the PU 202. By this, nitrogen flows into the lock hopper 34 from the non-combustible gas supply path 56. By this, the produced gas in the lock hopper 34 flows out to the mixed gas path 64.

FIG. 5 is a step of discharging the carbon 112 from the lock hopper 34. This step is a step following the step illustrated in FIG. 4. In this step, only the discharge valve 36 of the seven valves is brought into the open state by the PU 202. By this, the carbon 112 drops to the storage 38 in accordance with the action of gravity.

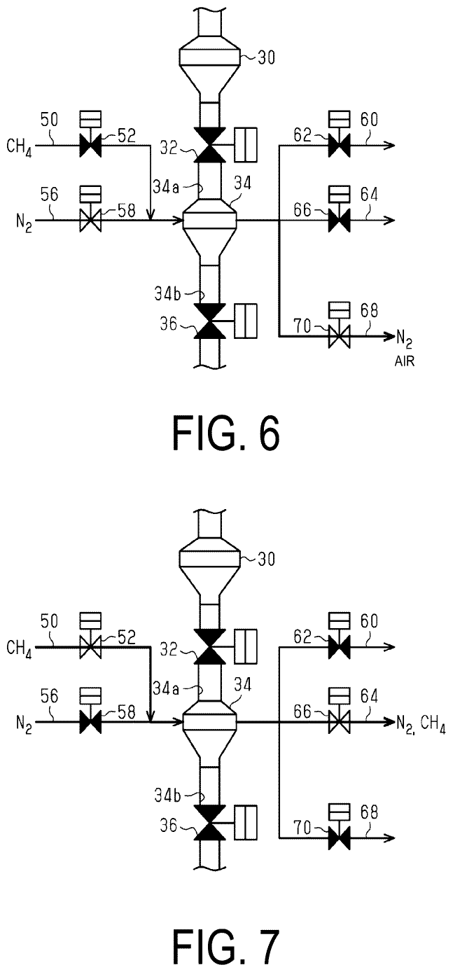

FIG. 6 illustrates a step of purging the oxygen in the lock hopper 34. This step is a step following the step illustrated in FIG. 5. In this step, only two valves of the non-combustible gas supply valve 58 and the non-combustible gas discharge valve 70 of the seven valves are brought into the open state by the PU 202. By this, nitrogen flows into the lock hopper 34 from the non-combustible gas supply path 56. Oxygen flows from the discharge port 34b to the lock hopper 34 in the step of FIG. 5. Therefore, this oxygen flows out to the non-combustible gas discharge path 68 as nitrogen flows into the lock hopper 34.

FIG. 7 illustrates a step of purging the nitrogen from the lock hopper 34. This step is a step following the step illustrated in FIG. 6. In this step, only two valves of the combustible gas supply valve 52 and the mixed gas valve 66 of the seven valves are brought into the open state by the PU 202. By this, methane flows into the lock hopper 34 from the combustible gas supply valve 52. Therefore, the nitrogen in the lock hopper 34 is discharged to the mixed gas path 64.

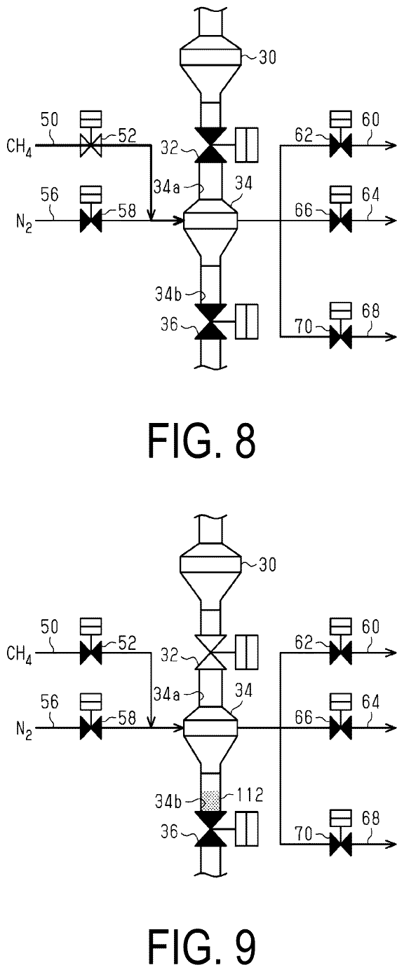

FIG. 8 illustrates a step of pressurizing the inside of the lock hopper 34. This step is a step following the step illustrated in FIG. 7. In this step, only the combustible gas supply valve 52 of the seven valves is brought into the open state by the PU 202. By this, the filling concentration of the methane in the lock hopper 34 increases, and the pressure in the lock hopper 34 increases. This step is a step of reducing the difference between the pressure in the lock hopper 34 and the pressure in the reactor 16. In this step, it is desirable to equalize the pressure in the supply hopper 30 and the pressure in the lock hopper 34.

FIG. 9 illustrates a step of depositing carbon in the lock hopper 34. This step is a step following the step illustrated in FIG. 8. In this step, only the introduction valve 32 of the seven valves is brought into the open state by the PU 202. By this, carbon is accumulated, whereby the state illustrated in FIG. 2 is realized.

### “Supply Process of Catalyst”

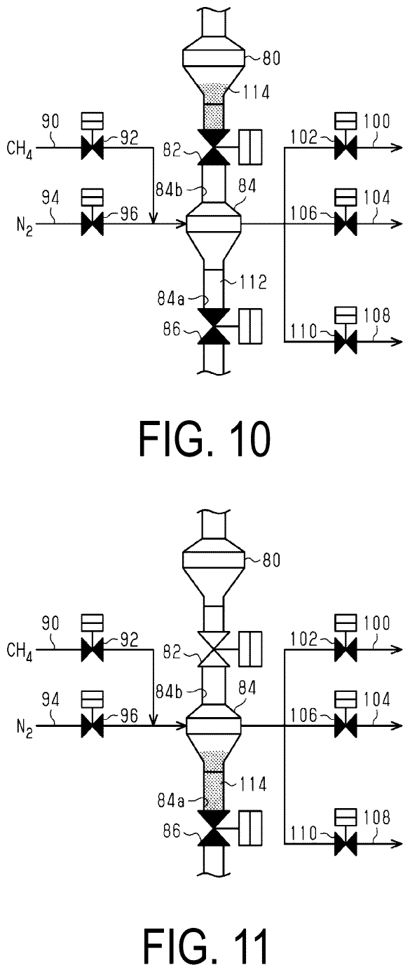

The supply hopper 80 described above is supplied with iron in a state of being open to the atmosphere. The lock hopper 84 is utilized in order to supply iron supplied under atmospheric pressure to a pressurized system including the reactor 16. Hereinafter, a supply process of a catalyst using the lock hopper 84 will be described with reference to FIGS. 10 to 18.

FIG. 10 illustrates a state in which iron 114 as a catalyst is supplied into the supply hopper 80. In this state, all of the seven valves of the introduction valve 82, the discharge valve 86, the combustible gas supply valve 92, the non-combustible gas supply valve 96, the produced gas valve 102, the mixed gas valve 106, and the non-combustible gas discharge valve 110 are in the closed state.

FIG. 11 illustrates a step of supplying the iron 114 to the lock hopper 84. This step is executed on the condition of being brought into the state in FIG. 10. In this step, only the introduction valve 82 of the seven valves is brought into the open state by the PU 202. By this, the iron 114 in the supply hopper 80 drops to the introduction port 84b of the lock hopper 84 by the action of gravity.

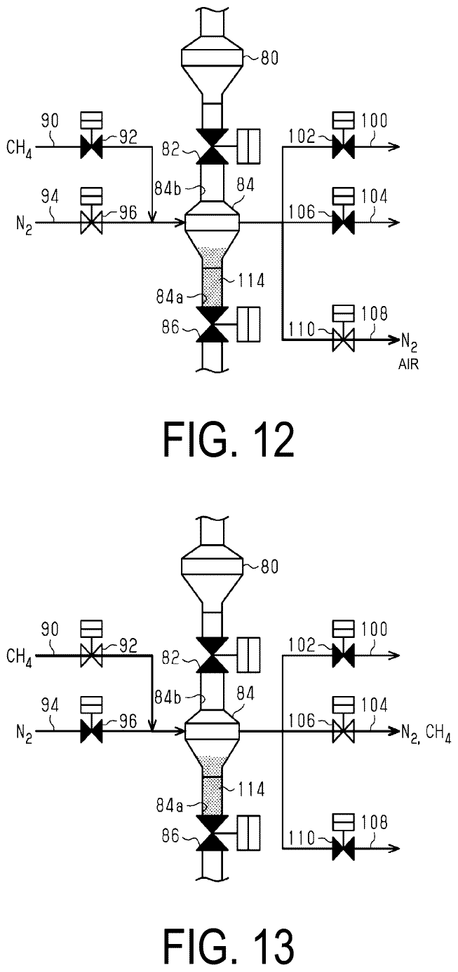

FIG. 12 illustrates a step of purging the oxygen in the lock hopper 84. This step is a step following the step illustrated in FIG. 11. In this step, only two valves of the non-combustible gas supply valve 96 and the non-combustible gas discharge valve 110 of the seven valves are brought into the open state by the PU 202. By this, nitrogen is supplied from the non-combustible gas supply valve 96 to the lock hopper 84. Oxygen flows from the supply hopper 80 to the lock hopper 84 in the step illustrated in FIG. 11. This oxygen is discharged from the non-combustible gas discharge path 108 as nitrogen flows into the lock hopper 84.

FIG. 13 illustrates a step of purging the nitrogen in the lock hopper 84. The step illustrated in FIG. 13 is a step following the step illustrated in FIG. 12. In this step, only two valves of the combustible gas supply valve 92 and the mixed gas valve 106 of the seven valves are brought into the open state by the PU 202. By this, methane flows into the lock hopper 84 from the combustible gas supply path 90. Therefore, the nitrogen in the lock hopper 84 is purged to the mixed gas path 104.

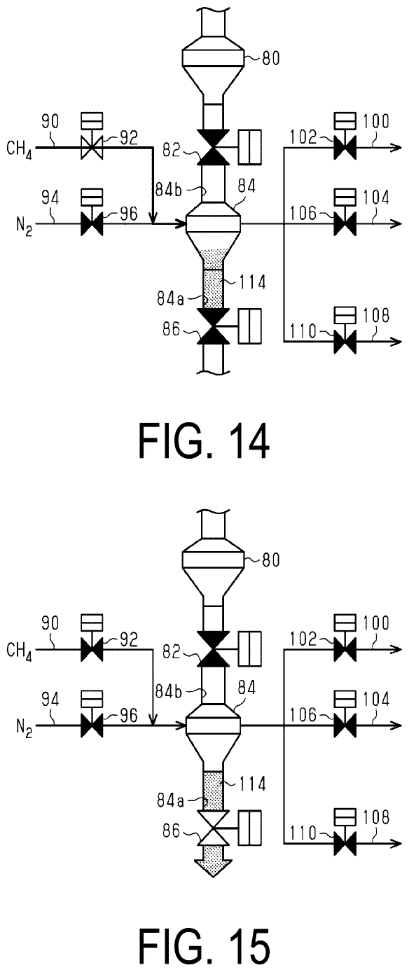

FIG. 14 illustrates a step of pressurizing the inside of the lock hopper 84. This step is a step following the step illustrated in FIG. 13. In this step, only the combustible gas supply valve 92 of the seven valves is brought into the open state by the PU 202. By this, methane flows into the lock hopper 84 from the combustible gas supply path 90. By this, the concentration of the methane in the lock hopper 84 increases, whereby the inside of the lock hopper 84 is pressurized. This step is provided in order to reduce the difference between the pressure in the lock hopper 84 and the pressure in the reactor 16. In this step, it is desirable to equalize the pressure in the lock hopper 84 and the pressure downstream of the discharge valve 86.

FIG. 15 illustrates a step of supplying the iron 114 to the reactor 16. This step is a step following the step illustrated in FIG. 14. In this step, only the discharge valve 86 of the seven valves is brought into the open state by the PU 202. By this, the iron 114 in the lock hopper 84 is discharged from the lock hopper 84 by the action of gravity.

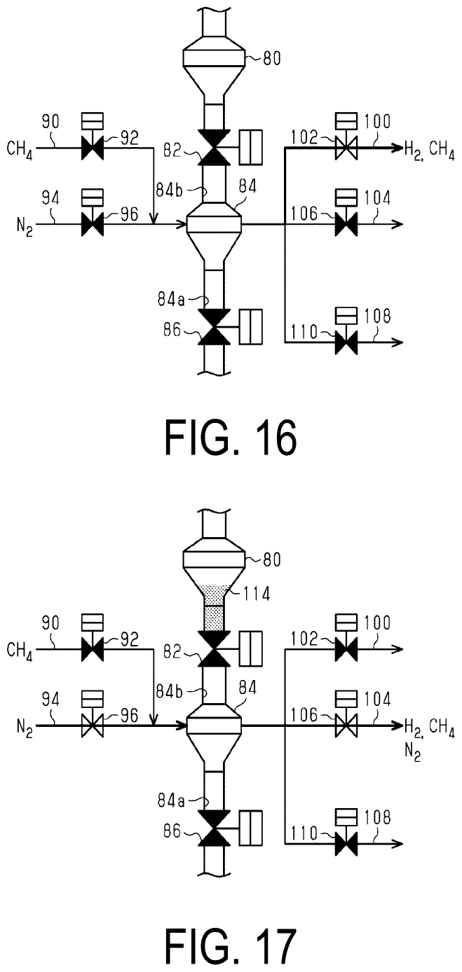

FIG. 16 illustrates a step of reducing the pressure in the lock hopper 84. This step is a step following the step illustrated in FIG. 15. In this step, only the produced gas valve 102 of the seven valves is brought into the open state by the PU 202. By this, the produced gas in the lock hopper 84 flows out to the produced gas path 100. Note that in the step illustrated in FIG. 15, the produced gas flows into the lock hopper 84 from the reactor 16 side. Therefore, the produced gas exists in the lock hopper 84 at the time point when the step of FIG. 16 is started.

FIG. 17 illustrates a step of purging the produced gas in the lock hopper 84. This step is a step following the step illustrated in FIG. 16. In this step, only two valves of the non-combustible gas supply valve 96 and the mixed gas valve 106 of the seven valves are brought into the open state by the PU 202. By this, nitrogen flows into the lock hopper 84 from the non-combustible gas supply path 94. By this, the produced gas in the lock hopper 84 is purged to the mixed gas path 104.

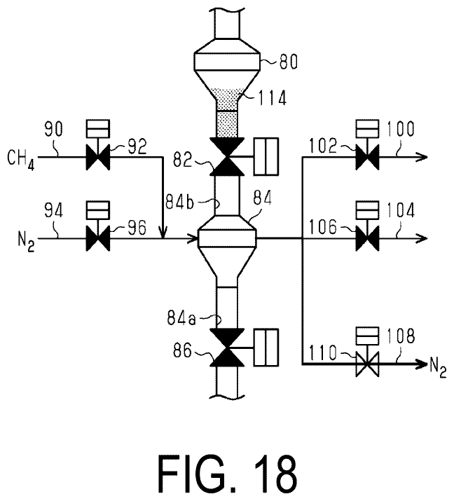

FIG. 18 illustrates a step of pressure-reducing the inside of the lock hopper 84. This step is a step following the step illustrated in FIG. 17. In this step, only the non-combustible gas discharge valve 110 of the seven valves is brought into the open state by the PU 202. By this, the nitrogen in the lock hopper 84 flows out to the non-combustible gas discharge valve 110, whereby the pressure in the lock hopper 84 becomes equivalent to the atmospheric pressure.

### Functions and Effects of Present Embodiment

(1-1) After purging oxygen in the lock hopper 34 with nitrogen in the step illustrated in FIG. 6, the PU 202 purged nitrogen from the lock hopper 34 by supplying methane to the lock hopper 34. This can suppress nitrogen from flowing into the reactor 16 side along with the opening of the introduction valve 32.
(1-2) Prior to the opening of the introduction valve 32, the PU 202 pressurized the lock hopper 34 as illustrated in FIG. 8. This can reduce the load necessary for opening the introduction valve 32. In particular, if the area of the introduction port 34a is large, the load applied to the valve opening remarkably increases when the difference between the pressure upstream of the introduction valve 32 and the pressure downstream thereof is large. In such case, prior to the opening of the introduction valve 32, by pressurizing the inside of the lock hopper 34, it is possible to reduce the load applied to the valve opening.

It is possible to suppress the pressure fluctuation on the reactor 16 side along with the opening of the introduction valve 32.
(1-3) After storing the carbon 112 in the lock hopper 34, the PU 202 opens the produced gas valve 62 in the step illustrated in FIG. 3. This can cause the mixture gas of methane and hydrogen in the lock hopper 34 to flow out to the produced gas path 60. This mixture gas is compressed by the off-gas compressor 28 and then supplied to the reactor 16. Therefore, it is possible to increase the production efficiency of hydrogen, which is the ratio of hydrogen produced by the system to methane supplied to the system.
(1-4) Prior to the step of purging the carbon 112 from the lock hopper 34 illustrated in FIG. 5, the PU 202 purged the mixture gas of hydrogen and methane from the lock hopper 34 to the mixed gas path 64 by supplying nitrogen to the lock hopper 34 in the step illustrated in FIG. 4. This can suppress the combustible gas from being released to the atmosphere along with the opening of the discharge valve 36. The mixture gas in the mixed gas path 64 is pressurized by the mixed gas compressor 72, and then hydrogen is extracted by the hydrogen refiner 74. This can increase the production efficiency of hydrogen, which is the ratio of hydrogen produced by the system to methane supplied to the system.
(1-5) After filling the lock hopper 84 with the catalyst, the PU 202 supplied nitrogen to the lock hopper 84 in the step illustrated in FIG. 12. By this, oxygen flowing into the lock hopper 84 in the step illustrated in FIG. 11 can be purged from the lock hopper 84 to the non-combustible gas discharge path 108.
(1-6) Prior to opening the discharge valve 86, the PU 202 purged the nitrogen in the lock hopper 84 to the mixed gas path 104 by supplying methane to the lock hopper 84 in the step illustrated in FIG. 13. This can suppress the nitrogen in the lock hopper 84 from flowing into the reactor 16.
(1-7) Prior to opening the discharge valve 86, the PU 202 pressurized the inside of the lock hopper 84 by increasing the methane concentration in the lock hopper 84 in the step illustrated in FIG. 14. This can reduce the load necessary for opening the discharge valve 86. In particular, if the area of the discharge port 84a is large, the load applied to the valve opening remarkably increases when the difference between the pressure upstream of the discharge valve 86 and the pressure downstream thereof is large. In such case, prior to the opening of the discharge valve 86, by pressurizing the inside of the lock hopper 84, it is possible to reduce the load applied to the valve opening.

It is possible to suppress the pressure fluctuation on the reactor 16 side along with the opening of the discharge valve 86.
(1-8) After supplying the iron 114 from the lock hopper 84 to the reactor 16, the PU 202 opened the produced gas valve 102. This can cause the mixture gas of methane and hydrogen in the lock hopper 84 to flow out to the produced gas path 100. This mixture gas is compressed by the off-gas compressor 28 and then supplied to the reactor 16. Therefore, it is possible to increase the production efficiency of hydrogen, which is the ratio of hydrogen produced by the system to methane supplied to the system.
(1-9) After the step illustrated in FIG. 16, the PU 202 purged the mixture gas of hydrogen and methane in the lock hopper 84 to the mixed gas path 104 by supplying nitrogen into the lock hopper 84. The mixture gas in the mixed gas path 104 is pressurized by the mixed gas compressor 72, and then hydrogen is extracted by the hydrogen refiner 74. This can increase the production efficiency of hydrogen, which is the ratio of hydrogen produced by the system to methane supplied to the system.
(1-10) After purging the mixture gas of hydrogen and methane in the lock hopper 84 to the mixed gas path 104, the PU 202 opened the inside of the lock hopper 84 to the atmosphere by opening the non-combustible gas discharge valve 110 in the step illustrated in FIG. 18. This can reduce the pressure difference between the upstream side and the downstream side of the introduction valve 82 when the introduction valve 82 is opened thereafter.

### Second Embodiment

Hereinafter, the second embodiment will be described with reference to the drawings, focusing on differences from the first embodiment.

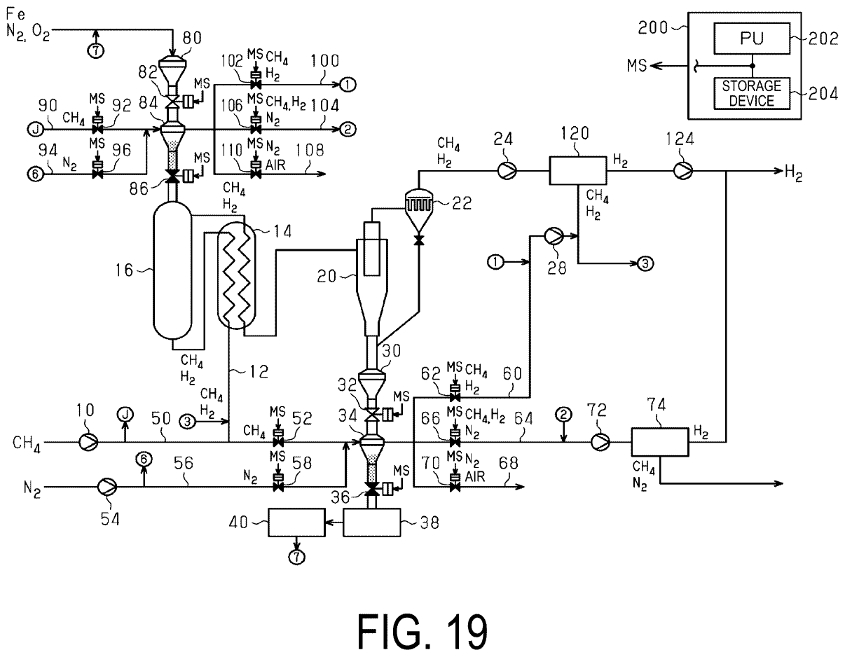

FIG. 19 illustrates the production system of the combustion gas according to the present embodiment. Note that in FIG. 19, members corresponding to the members illustrated in FIG. 1 are denoted by identical reference signs for convenience.

In the present embodiment, the mixture gas of hydrogen and methane flowing out of the filter device 22 is supplied to a hydrogen refiner 120. The hydrogen refiner 120 is a device including a separation membrane to separate hydrogen from the mixture gas. The hydrogen separated by the hydrogen refiner 120 has a lower pressure compared with the hydrogen extracted by the hydrogen refiner 26. Therefore, in the present embodiment, the hydrogen separated by the hydrogen refiner 120 is pressurized by a compressor 124.

The methane separated by the hydrogen refiner 120 has a high pressure. Therefore, the methane separated by the hydrogen refiner 120 is returned to the feedstock gas path 12 without passing through the off-gas compressor 28.

### Third Embodiment

Hereinafter, the third embodiment will be described with reference to the drawings, focusing on differences from the second embodiment.

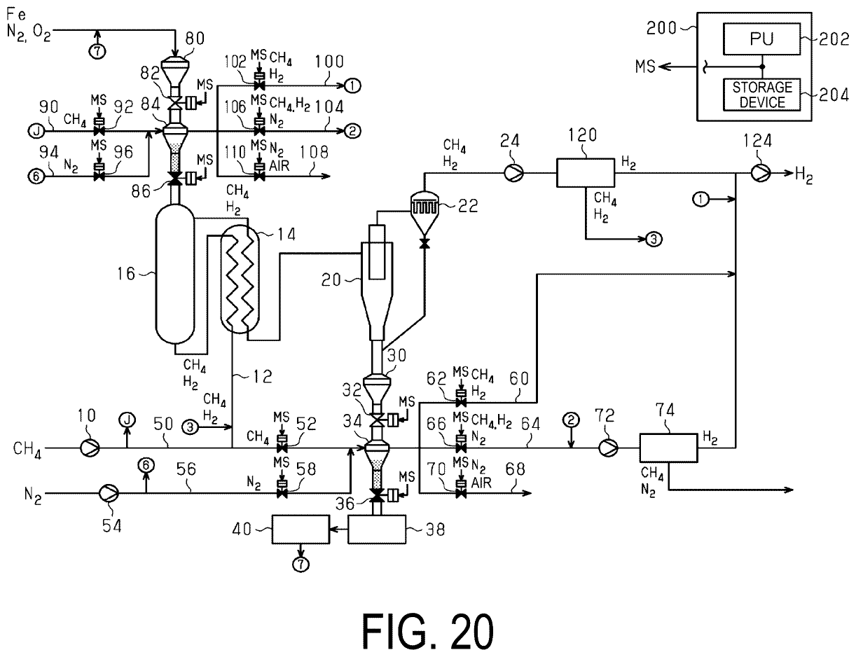

FIG. 20 illustrates the production system of the combustion gas according to the present embodiment. Note that in FIG. 20, members corresponding to the members illustrated in FIG. 19 are denoted by identical reference signs for convenience.

In the present embodiment, the mixture gas in the produced gas paths 60 and 100 is supplied to the compressor 124. Due to this, the final produced gas of the system is mixed with a trace of methane. The present embodiment is a system that allows a final product to be mixed with a trace of methane.

### Fourth Embodiment

Hereinafter, the fourth embodiment will be described with reference to the drawings, focusing on differences from the first embodiment.

In the present embodiment, one step is added to each of the steps illustrated in FIGS. 2 to 9 and the steps illustrated in FIGS. 10 to 18.

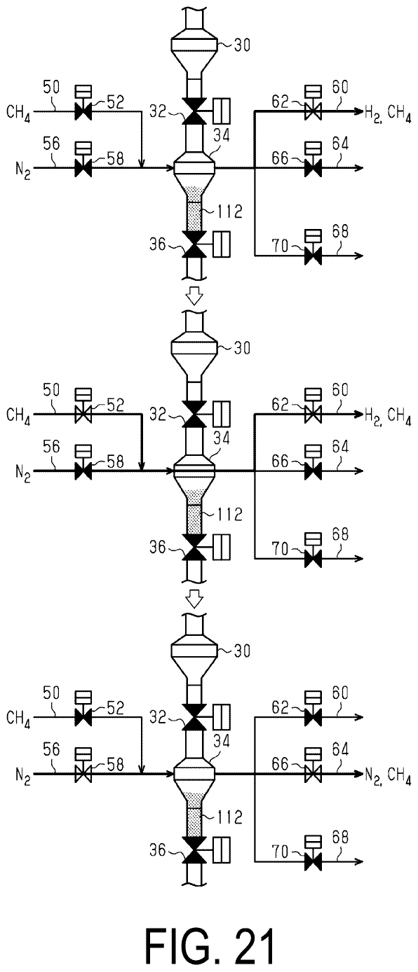

FIG. 21 illustrates a part of the discharge process of carbon. The step illustrated in the upper part of FIG. 21 is the step illustrated in FIG. 3. The step illustrated in the lower part of FIG. 21 is the step illustrated in FIG. 4. In the present embodiment, the step illustrated in the middle part of FIG. 21 is added between these steps.

The step illustrated in the middle part of FIG. 21 is a step of purging a produced gas that is a mixture gas of hydrogen and methane in the lock hopper 34. In this step, only two valves of the combustible gas supply valve 52 and the produced gas valve 62 of the seven valves are brought into the open state by the PU 202. By this, methane flows into the lock hopper 34 from the combustible gas supply path 50. Therefore, the produced gas in the lock hopper 34 is purged to the produced gas path 60. Therefore, in the step in the lower part of FIG. 21, the gas flowing out to the mixed gas path 64 is a mixture gas of methane and nitrogen.

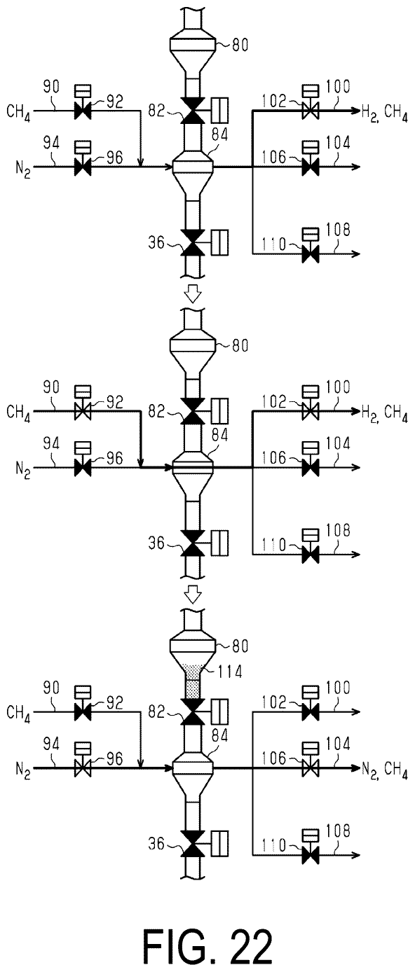

FIG. 22 illustrates a part of the supply process of catalyst. The step illustrated in the upper part of FIG. 22 is the step illustrated in FIG. 16. The step illustrated in the lower part of FIG. 22 is the step illustrated in FIG. 17. In the present embodiment, the step illustrated in the middle part of FIG. 22 is added between these steps.

The step illustrated in the middle part of FIG. 22 is a step of purging a produced gas that is a mixture gas of hydrogen and methane in the lock hopper 84. In this step, only two valves of the combustible gas supply valve 92 and the produced gas valve 102 of the seven valves are brought into the open state by the PU 202. By this, methane flows into the lock hopper 84 from the combustible gas supply path 90. Therefore, the produced gas in the lock hopper 84 is purged to the produced gas path 100. Therefore, in the step in the lower part of FIG. 22, the gas flowing out to the mixed gas path 104 is a mixture gas of methane and nitrogen.

Therefore, the hydrogen refiner 74 illustrated in FIG. 1 becomes unnecessary.

### Correspondence Relationship

Correspondence relationship between the matters and the like in the above embodiments and the matters described in the following “Supplementary Notes” is as follows. Hereinafter, the correspondence relationship is presented for each number of the solutions described in the section “Supplementary Note”.
[1] The solid movement step corresponds to the step illustrated in FIG. 5 and the step illustrated in FIG. 15. The non-combustible gas introduction step corresponds to the step illustrated in FIG. 6 and the step illustrated in FIG. 12. The discharge step corresponds to the step illustrated in FIG. 7 and the step illustrated in FIG. 13.
[2] The combustible gas discharge passage corresponds to the produced gas path 60 and the mixed gas path 64 in FIGS. 2 to 9 and the produced gas path 100 and the mixed gas path 104 in FIGS. 10 to 18. The non-combustible gas discharge path corresponds to the non-combustible gas discharge path 68 in FIGS. 2 to 9 and the non-combustible gas discharge path 108 in FIGS. 10 to 18. The non-combustible gas supply path corresponds to the non-combustible gas supply path 56 in FIGS. 2 to 9 and the non-combustible gas supply path 94 in FIGS. 10 to 18. The oxygen purge step corresponds to the step illustrated in FIG. 6 and the step illustrated in FIG. 12. The non-combustible gas purge step corresponds to the step illustrated in FIG. 7 and the step illustrated in FIG. 13.
[3] The combustible gas purge step corresponds to the step illustrated in FIG. 4 and the step illustrated in FIG. 17.
[4] The produced gas extraction step corresponds to the step illustrated in FIG. 3 and the step illustrated in FIG. 16.
[5] The combustible gas supply path corresponds to the combustible gas supply path 50 in FIGS. 2 to 9 and the combustible gas supply path 90 in FIGS. 10 to 18.
[6] The pressurization step corresponds to the steps illustrated in FIGS. 8 and 14.
[7] The solid material dispensing step corresponds to the step illustrated in FIG. 5.
[8] The solid material storage step corresponds to the step illustrated in FIG. 9. The depressurization step corresponds to the step illustrated in FIG. 3. The produced gas purge step corresponds to the step illustrated in FIG. 4.
[9] The Produced Gas Recovery Step Corresponds to the Step Illustrated in the middle part of FIG. 21.
[10]

The pressurization step corresponds to the step illustrated in FIG. 8.
[11] The solid material reception step corresponds to the step illustrated in FIG. 11. The catalyst corresponds to the iron 114.
[12] The combustible gas supply path corresponds to the combustible gas supply path 90. The pressurization step corresponds to the step illustrated in FIG. 14. The solid material dispensing step corresponds to the step illustrated in FIG. 15.
[13] The depressurization step corresponds to the step illustrated in FIG. 16.
[14] The produced gas purge step corresponds to the step illustrated in FIG. 17.
[15] The produced gas recovery step corresponds to the step illustrated in the middle part of FIG. 22.
[16] The non-combustible gas discharge step corresponds to the step illustrated in FIG. 18.
[17] In FIGS. 1 and 19, the produced gas paths 60 and 100 correspond to being connected to the off-gas compressor 28. In FIGS. 1, 19, and 20, the mixed gas path 64 corresponds to being connected to the hydrogen refiner 74. In FIG. 20, the produced gas paths 60 and 100 correspond to being connected to the compressor 124.
[18] The combustible gas discharge passage corresponds to the produced gas path 60 and the mixed gas path 64 in FIGS. 2 to 9 and the produced gas path 100 and the mixed gas path 104 in FIGS. 10 to 18. The non-combustible gas supply path corresponds to the non-combustible gas supply path 56 in FIGS. 2 to 9 and the non-combustible gas supply path 94 in FIGS. 10 to 18.
[19 ] The non-combustible gas discharge path corresponds to the non-combustible gas discharge path 68 in FIGS. 2 to 9 and the non-combustible gas discharge path 108 in FIGS. 10 to 18.
[20] It corresponds to the produced gas paths 60 and 100 and the mixed gas paths 64 and 104.
[21] The combustible gas supply path corresponds to the combustible gas supply path 50 in FIGS. 2 to 9 and the combustible gas supply path 90 in FIGS. 10 to 18.

### Other Embodiments

Note that it is possible to implement the present embodiment by modifying as follows. The present embodiment and the following modification examples can be implemented in combination with each other within a range not technically contradictory.

### “Regarding Connection Destination of Produced Gas Path”

For example, the produced gas path 60 may be connected to a compressor by providing the compressor that pressurizes and supplies, to the compressor 24, the mixture gas of hydrogen and methane in the produced gas path 60.
For example, the produced gas path 100 may be connected to a compressor by providing the compressor that pressurizes and supplies, to the compressor 24, the mixture gas of hydrogen and methane in the produced gas path 100.

### “Regarding Connection Destination of Mixed Gas Path”

The mixed gas path 64 may be connected to an entrance of a gas turbine, for example. At that time, a compressor may be provided between the mixed gas path 64 and the gas turbine.
The mixed gas path 104 may be connected to an entrance of a gas turbine, for example. At that time, a compressor may be provided between the mixed gas path 104 and the gas turbine.

### “Regarding Combustible Gas Production System”

The hydrogen refiner 26 and the hydrogen refiner 74 may be deleted from the systems illustrated in FIGS. 1 and 20. In that case, for example, a gas turbine may be disposed at the positions of the hydrogen refiner 26 and the hydrogen refiner 74. This can configure a power generation system or the like in which part of the fuel is hydrogen.
The hydrogen refiner 120 and the hydrogen refiner 74 may be deleted from the system illustrated in FIG. 19. In that case, a gas turbine may be disposed at the positions of the hydrogen refiner 120 and the hydrogen refiner 74. This can configure a power generation system or the like in which part of the fuel is hydrogen.

### “Regarding Combustible Gas Discharge Path”

It is not essential for the combustible gas discharge path connected to the lock hopper 34 to include the produced gas path 60 and the mixed gas path 64. For example, they may be a common path. In that case, a hydrogen refiner that extracts hydrogen from the mixture gas flowing out of the combustible gas discharge path may be provided.
It is not essential for the combustible gas discharge path connected to the lock hopper 84 to include the produced gas path 100 and the mixed gas path 104. For example, they may be a common path. In that case, a hydrogen refiner that extracts hydrogen from the mixture gas flowing out of the combustible gas discharge path may be provided.

### “Regarding Combustible Gas Supply Path”

It is not essential to include the combustible gas supply path 50. In the case of not including the combustible gas supply path 50, a step of opening the introduction valve 32 while bringing the mixed gas valve 66 into a valve opening state may be provided in place of the steps illustrated in FIGS. 7 and 8. By this, nitrogen can be purged to the mixed gas path 64 by entry of a substance from the supply hopper 30 side.

### “Regarding Solid Movement Device”

In a case where the produced gas path 60 and the mixed gas path 64 are one common path as described in the section “Regarding combustible gas discharge path”, the produced gas valve 62 and the mixed gas valve 66 may be one valve in place of them.
In a case where the produced gas path 100 and the mixed gas path 104 are one common path as described in the section “Regarding combustible gas discharge path”, the produced gas valve 102 and the mixed gas valve 106 may be one valve in place of them.

### “Regarding Hydrocarbon”

The hydrocarbon that is a target of thermal decomposition is not limited to methane. For example, it may be propane.

### “Regarding Non-Combustible Gas”

The non-combustible gas to be supplied from the non-combustible gas supply path to the lock hopper is not limited to nitrogen. For example, it may be helium.

### “Regarding Pressure of System”

It is not essential for any one of the introduction port and the discharge port of the lock hopper to be open to the atmosphere and the other to be higher than the atmospheric pressure. For example, one may be open to the atmosphere and the other may be lower than the atmospheric pressure. For example, although both are higher than the atmospheric pressure, there may be a large difference between those pressures.

### “Regarding Control Device”

The control device is not limited to one that executes software processing. For example, a dedicated hardware circuit such as an ASIC that executes at least part of the processing to be executed in the above embodiments may be included. That is, the control device may include a processing circuit having any of the following configurations (a) to (c). (a) A processing circuit including: a processing device that executes all of the above processing according to a program; and a program storage device such as a storage device that stores the program. (b) A processing circuit including: a processing device that executes part of the above processing according to a program; a program storage device; and a dedicated hardware circuit that executes the remaining processing. (c) A processing circuit including: a dedicated hardware circuit that executes all of the above processing. Here, a plurality of software execution devices including the processing device and the program storage device may be included. A plurality of dedicated hardware circuits may be included.

### Supplementary Notes

Solution 1. A method for operating a lock hopper, the method including a solid movement step, in which the solid movement step is a step of moving a solid from either one of an inside of a combustible gas production system and an outside of the combustible gas production system to the other one by introducing a solid into a lock hopper or discharging the solid from the lock hopper, the combustible gas production system is a system that produces a combustible gas, the method includes a non-combustible gas introduction step and a discharge step, the non-combustible gas introduction step is a step of introducing a non-combustible gas into a lock hopper from a path different from an introduction port for the solid and a discharge port for the solid, and the discharge step is a step of discharging a gas in the lock hopper from the lock hopper by using a path different from an introduction port for the solid and a discharge port for the solid.

If the non-combustible gas introduced in the non-combustible gas introduction step is discharged in the discharge step, it is possible to suppress an increase in concentration of the non-combustible gas in a path that is on either side of the introduction port or the discharge port in the lock hopper and is not intended for mixture of the non-combustible gas. In the discharge step, if the combustible gas is purged from the lock hopper by the non-combustible gas introduced in the non-combustible gas introduction step, the combustible gas can be suppressed from flowing out of the system in the solid movement step.
Solution 2. The method for operating a lock hopper according to solution 1 described above, in which the non-combustible gas introduction step includes an oxygen purge step, the discharge step includes a non-combustible gas purge step, the lock hopper is connected to a combustible gas discharge path, a non-combustible gas discharge path, and a non-combustible gas supply path, separately from an introduction port for the solid and a discharge port for the solid, the combustible gas discharge path is a path through which a gas containing a combustible gas is discharged from the lock hopper, the oxygen purge step is a step of supplying the non-combustible gas from the non-combustible gas supply path to the lock hopper while bringing the lock hopper and the non-combustible gas discharge path into a communication state, to purge oxygen by a non-combustible gas in a state where oxygen exists in the lock hopper, and the non-combustible gas purge step is a step of discharging the non-combustible gas in the lock hopper from the lock hopper to the combustible gas discharge path by supplying a combustible gas to the lock hopper while bringing the lock hopper and the combustible gas discharge path into a communication state, and is a step to be executed after the oxygen purge step.

According to the above method, after the oxygen in the lock hopper is purged by the non-combustible gas, the combustible gas is supplied to the lock hopper. This can purge, from the lock hopper, the non-combustible gas used for purge of the oxygen.
Solution 3. The method for operating a lock hopper according to solution 1 described above, in which the lock hopper is connected to a combustible gas discharge path and a non-combustible gas supply path separately from an introduction port for the solid and a discharge port for the solid, the combustible gas discharge path is a path through which a gas containing a combustible gas is discharged from the lock hopper, the non-combustible gas introduction step and the discharge step include a combustible gas purge step, the combustible gas purge step is a step of supplying a non-combustible gas from the non-combustible gas supply path to the lock hopper while bringing the lock hopper and the combustible gas discharge path into a communication state in a state where the combustible gas is contained in the lock hopper, and the solid movement step is executed after the combustible gas purge step.

In the above method, prior to the solid movement step, the combustible gas can be purged from the lock hopper by supplying the non-combustible gas to the lock hopper. Therefore, in the solid movement step, the combustible gas can be suppressed from flowing out of the combustible gas production system.
Solution 4. The method for operating a lock hopper according to solution 2 described above, in which the combustible gas discharge path includes a produced gas path and a mixed gas path, the produced gas path is a path for extracting the combustible gas from the lock hopper, the mixed gas path is a path for extracting the combustible gas and the non-combustible gas from the lock hopper, the non-combustible gas purge step is a step of discharging the non-combustible gas in the lock hopper to the mixed gas path, the method includes a produced gas extraction step, the produced gas extraction step is a step of causing the produced gas in the lock hopper to flow out to the produced gas path by bringing the lock hopper and the produced gas path into a communication state in a state where a produced gas exists in the lock hopper, and the produced gas is the combustible gas produced by the combustible gas production system.

According to the produced gas extraction step, it is possible to cause the produced gas in the lock hopper to flow out to a produced gas path different from the mixed gas path. This enables the produced gas in the produced gas path to be treated separately from the gas in the mixed gas path.
Solution 5. The method for operating a lock hopper according to solution 2 or 4 described above, in which the combustible gas supplied to the lock hopper is hydrocarbon, a feedstock used by the combustible gas production system is hydrocarbon, the combustible gas that is a production target by the combustible gas production system is hydrogen, the lock hopper is connected to a combustible gas supply path, and the non-combustible gas purge step is a step of supplying the hydrocarbon from the combustible gas supply path to the lock hopper while bringing the lock hopper and the combustible gas discharge path into a communication state.

In the above method, the non-combustible gas in the lock hopper can be purged to the combustible gas discharge path by supplying the hydrocarbon to the lock hopper.
Solution 6. The method for operating a lock hopper according to solution 5 described above, the method including a pressurization step, in which the pressurization step is a step of supplying the hydrocarbon from the combustible gas supply path to the lock hopper while shutting off an inside of the lock hopper from the combustible gas discharge path, and is a step to be executed after the non-combustible gas purge step.

According to the pressurization step, the inside of the lock hopper can be pressurized. Therefore, the pressure difference from the pressurization space communicable with the lock hopper can be reduced.
Solution 7. The method for operating a lock hopper according to any one of solutions 2 and 4 to 6 described above, in which the solid movement step is a solid material dispensing step, the solid material dispensing step is a step of discharging carbon from the lock hopper to an outside of the combustible gas production system by opening the discharge port, in a state where the carbon, as the solid, is filled in the lock hopper, in which the carbon has been produced together with a produced gas, which is a mixture gas of hydrocarbon and hydrogen, by thermal decomposition of the hydrocarbon, and the oxygen purge step is a step of purging, from the lock hopper, oxygen having entered the lock hopper in the solid material dispensing step.

By the solid material dispensing step, oxygen enters the lock hopper from the discharge port. Therefore, in the above method, the oxygen having entered can be purged to the outside of the lock hopper in the oxygen purge step.
Solution 8. The method for operating a lock hopper according to solution 7 described above, the method including a solid material storage step, a depressurization step, and a produced gas purge step, in which the solid material storage step is a step of receiving the carbon produced by the thermal decomposition from the introduction port into the lock hopper, the depressurization step is a step of discharging the produced gas from the lock hopper to the combustible gas discharge path in a state where the introduction port is shut off, the produced gas purge step is a step of discharging the produced gas in the lock hopper to the combustible gas discharge path by supplying the non-combustible gas from the non-combustible gas supply path to the lock hopper after the depressurization step, and the solid material dispensing step is executed after the produced gas purge step.

According to the produced gas purge step, prior to discharging the carbon in the lock hopper from the discharge port, the produced gas in the lock hopper can be purged to the outside of the lock hopper. Therefore, the produced gas can be suppressed from flowing out of the discharge port.
Solution 9. The method for operating a lock hopper according to solution 8 described above, in which the combustible gas discharge path includes a produced gas path and a mixed gas path, the produced gas path is a path for extracting the produced gas from the lock hopper, the mixed gas path is a path for extracting the combustible gas and the non-combustible gas from the lock hopper, the lock hopper is connected to a combustible gas supply path, the method includes a produced gas recovery step, the produced gas recovery step is a step of discharging the produced gas in the lock hopper to the produced gas path by supplying the hydrocarbon from the combustible gas supply path to the lock hopper, and is a step to be executed between the depressurization step and the produced gas purge step, and the produced gas purge step is a step of discharging the hydrocarbon in the lock hopper to the mixed gas path.

According to the produced gas recovery step, the produced gas can be recovered in the produced gas path.
Solution 10. The method for operating a lock hopper according to solution 8 or 9 described above, in which the thermal decomposition of the hydrocarbon is performed in a state where a pressure of the hydrocarbon is higher than atmospheric pressure, the lock hopper is connected to a combustible gas supply path, the method includes a pressurization step, the pressurization step is a step of pressurizing an inside of the lock hopper by supplying the hydrocarbon from the combustible gas supply path to the lock hopper, and the solid material storage step is executed after the pressurization step.

According to the pressurization step, the pressure difference between the pressure in the lock hopper and the pressure in the space where the thermal decomposition is performed can be reduced.
Solution 11. The method for operating a lock hopper according to any one of solutions 2 to 10 described above, in which the combustible gas supplied to the lock hopper is hydrocarbon, a feedstock used by the combustible gas production system is hydrocarbon, the combustible gas that is a production target by the combustible gas production system is hydrogen, the solid movement step includes a solid material reception step, the solid material reception step is a step of supplying a catalyst as the solid for thermally decomposing the hydrocarbon into hydrogen and carbon, from an outside of the combustible gas production system to the lock hopper through the introduction port, and the oxygen purge step is a step of purging, from the lock hopper, oxygen having entered the lock hopper in the solid material reception step.

According to the solid material reception step, oxygen flows into the lock hopper. Therefore, in the above method, by providing the oxygen purge step, it is possible to purge, to the outside of the lock hopper, the oxygen flowed into the lock hopper.
Solution 12. The method for operating a lock hopper according to solution 11 described above, in which the lock hopper is connected to a combustible gas supply path, the method includes a pressurization step and a solid material dispensing step, the pressurization step is a step of pressurizing an inside of the lock hopper by supplying the hydrocarbon from the combustible gas supply path to the lock hopper, the solid material dispensing step is a step of discharging the catalyst from the discharge port to supply the catalyst to a side close to a reactor for the thermal decomposition, and is a step to be executed after the pressurization step, and a pressure in the reactor is higher than atmospheric pressure.

According to the pressurization step, the pressure difference between the inside of the lock hopper and the reactor side can be reduced.
Solution 13. The method for operating a lock hopper according to solution 12 described above, the method including a depressurization step, in which the depressurization step is a step of discharging, from the combustible gas discharge path, a produced gas flowed into the lock hopper in the solid material dispensing step, and the produced gas is a mixture gas of the hydrocarbon and hydrogen produced by thermal decomposition of the hydrocarbon.

According to the depressurization step, the concentration of the produced gas in the lock hopper can be reduced.
Solution 14. The method for operating a lock hopper according to solution 13 described above, the method including a produced gas purge step, in which the produced gas purge step is a step of discharging the produced gas from the lock hopper to the combustible gas discharge path by supplying a non-combustible gas from the non-combustible gas supply path to the lock hopper while bringing the lock hopper and the combustible gas discharge path into a communication state after the depressurization step.

According to the combustible gas purge step, the produced gas in the lock hopper can be purged by the non-combustible gas.
Solution 15. The method for operating a lock hopper according to solution 14 described above, in which the combustible gas discharge path includes a produced gas path and a mixed gas path, the produced gas path is a path for extracting the produced gas from the lock hopper, the mixed gas path is a path for extracting the produced gas and the non-combustible gas from the lock hopper, the depressurization step is a step of discharging the produced gas to the produced gas path, the produced gas purge step is a step of discharging the produced gas from the lock hopper to the mixed gas path, the lock hopper is connected to a combustible gas supply path, the method includes a produced gas recovery step, and the produced gas recovery step is a step of discharging the produced gas in the lock hopper to the produced gas path by supplying the hydrocarbon from the combustible gas supply path to the lock hopper, and is a step to be executed between the depressurization step and the produced gas purge step.

According to the produced gas recovery step, the produced gas can be recovered in the produced gas path. Therefore, the produced gas can be suppressed from flowing out to the mixed gas path.
Solution 16. The method for operating a lock hopper according to solution 14 or 15 described above, the method including a non-combustible gas discharge step, in which the non-combustible gas discharge step is a step of discharging the non-combustible gas from the lock hopper to the non-combustible gas discharge path after the produced gas purge step, and the solid material reception step is executed after the non-combustible gas purge step.

By providing the non-combustible gas purge step, as compared with a case of not providing it, it is possible to reduce the pressure in the lock hopper immediately before execution of the solid material reception step.
Solution 17. The method for operating a lock hopper according to solution 3 described above, in which the combustible gas discharged from the lock hopper to the combustible gas discharge path is returned to a path for producing a production target gas in the combustible gas production system.

According to the above method, the combustible gas can be effectively utilized for production of the production target gas.
Solution 18: A solid movement device including a lock hopper, the lock hopper being utilized for moving a solid from either one of an inside of a combustible gas production system and an outside of the combustible gas production system to the other one, in which the combustible gas production system is a system that produces a combustible gas, the lock hopper is connected to a discharge path and a non-combustible gas supply path separately from an introduction port for the solid and a discharge port for the solid, a combustible gas discharge path is a path through which a gas containing a combustible gas is discharged from the lock hopper, and a non-combustible gas supply path is a path for supplying a non-combustible gas to the lock hopper.

If the non-combustible gas introduced from the non-combustible gas supply path is discharged from the discharge path, it is possible to suppress an increase in concentration of the non-combustible gas in a path that is on either side of the introduction port or the discharge port in the lock hopper and is not intended for mixture of the non-combustible gas. If the combustible gas is purged from the lock hopper to the discharge path by the non-combustible gas introduced from the non-combustible gas supply path, the combustible gas can be suppressed from flowing out of the system when the solid is moved from any one to the other of the inside of the system and the outside of the system.
Solution 19. The solid movement device according to solution 18 described above, in which the discharge path includes a combustible gas discharge path and a non-combustible gas discharge path, the combustible gas discharge path is a path through which a gas containing a combustible gas in the lock hopper is discharged, and the non-combustible gas discharge path is a path through which a non-combustible gas in the lock hopper is released to atmosphere.

In the above configuration, since the discharge path includes the path for releasing the non-combustible gas to the atmosphere and the path for discharging the combustible gas, the combustible gas can be suppressed from flowing out to the atmosphere.
Solution 20. The solid movement device according to solution 19 described above, in which the combustible gas discharge path includes a produced gas path and a mixed gas path, the produced gas path is a path for extracting the combustible gas from the lock hopper, and the mixed gas path is a path for extracting the combustible gas and the non-combustible gas from the lock hopper.

In the above configuration, since the combustible gas discharge path includes the produced gas path and the mixed gas path, different paths from each other can be utilized depending on whether or not the non-combustible gas is contained in the lock hopper when the combustible gas is purged from the lock hopper.
Solution 21: The solid movement device according to any one of solutions 18 to 20 described above, in which the lock hopper is connected to a combustible gas supply path, and the combustible gas supply path is a path for supplying a combustible gas to the lock hopper.

In the above configuration, by supplying the combustible gas from the combustible gas supply path to the lock hopper, it is possible to purge the non-combustible gas in the lock hopper from the lock hopper.

1. A method for operating a lock hopper, the method including a solid movement step, wherein
the solid movement step is a step of moving a solid from either one of an inside of a combustible gas production system and an outside of the combustible gas production system to another one of the inside of the combustible gas production system and the outside of the combustible gas production system, by introducing a solid into a lock hopper or discharging the solid from the lock hopper,
the combustible gas production system is a system that produces a combustible gas,
the method includes a non-combustible gas introduction step and a discharge step,
the non-combustible gas introduction step is a step of introducing a non-combustible gas into a lock hopper from a path different from an introduction port for the solid and a discharge port for the solid, and
the discharge step is a step of discharging a gas in the lock hopper from the lock hopper by using a path different from an introduction port for the solid and a discharge port for the solid.

2. The method for operating a lock hopper according to claim 1, wherein
the non-combustible gas introduction step includes an oxygen purge step,
the discharge step includes a non-combustible gas purge step,
the lock hopper is connected to a combustible gas discharge path, a non-combustible gas discharge path, and a non-combustible gas supply path, separately from an introduction port for the solid and a discharge port for the solid,
the combustible gas discharge path is a path through which a gas containing a combustible gas is discharged from the lock hopper,
the oxygen purge step is a step of supplying the non-combustible gas from the non-combustible gas supply path to the lock hopper while bringing the lock hopper and the non-combustible gas discharge path into a communication state, to purge oxygen by a non-combustible gas in a state where oxygen exists in the lock hopper, and
the non-combustible gas purge step is a step of discharging the non-combustible gas in the lock hopper from the lock hopper to the combustible gas discharge path by supplying a combustible gas to the lock hopper while bringing the lock hopper and the combustible gas discharge path into a communication state, and is a step to be executed after the oxygen purge step.

3. The method for operating a lock hopper according to claim 1, wherein
the lock hopper is connected to a combustible gas discharge path and a non-combustible gas supply path separately from the introduction port for the solid and the discharge port for the solid,
the combustible gas discharge path is a path through which a gas containing a combustible gas is discharged from the lock hopper,
the non-combustible gas introduction step and the discharge step include a combustible gas purge step,
the combustible gas purge step is a step of supplying a non-combustible gas from the non-combustible gas supply path to the lock hopper while bringing the lock hopper and the combustible gas discharge path into a communication state in a state where the combustible gas is contained in the lock hopper, and
the solid movement step is executed after the combustible gas purge step.

4. The method for operating a lock hopper according to claim 2, wherein
the combustible gas discharge path includes a produced gas path and a mixed gas path,
the produced gas path is a path for extracting the combustible gas from the lock hopper,
the mixed gas path is a path for extracting the combustible gas and the non-combustible gas from the lock hopper,
the non-combustible gas purge step is a step of discharging the non-combustible gas in the lock hopper to the mixed gas path,
the method includes a produced gas extraction step,
the produced gas extraction step is a step of causing the produced gas in the lock hopper to flow out to the produced gas path by bringing the lock hopper and the produced gas path into a communication state in a state where a produced gas exists in the lock hopper, and
the produced gas is the combustible gas produced by the combustible gas production system.

5. The method for operating a lock hopper according to claim 2, wherein
the combustible gas supplied to the lock hopper is hydrocarbon,
a feedstock used by the combustible gas production system is hydrocarbon,
the combustible gas that is a production target by the combustible gas production system is hydrogen,
the lock hopper is connected to a combustible gas supply path, and
the non-combustible gas purge step is a step of supplying the hydrocarbon from the combustible gas supply path to the lock hopper while bringing the lock hopper and the combustible gas discharge path into a communication state.

6. The method for operating a lock hopper according to claim 5, the method comprising
a pressurization step, wherein
the pressurization step is a step of supplying the hydrocarbon from the combustible gas supply path to the lock hopper while shutting off an inside of the lock hopper from the combustible gas discharge path, and is a step to be executed after the non-combustible gas purge step.

7. The method for operating a lock hopper according to claim 2, wherein
the solid movement step is a solid material dispensing step,
the solid material dispensing step is a step of discharging carbon from the lock hopper to an outside of the combustible gas production system by opening the discharge port, in a state where the carbon, as the solid, is filled in the lock hopper, wherein the carbon has been produced together with a produced gas, which is a mixture gas of hydrocarbon and hydrogen, by thermal decomposition of the hydrocarbon, and
the oxygen purge step is a step of purging, from the lock hopper, oxygen having entered the lock hopper in the solid material dispensing step.

8. The method for operating a lock hopper according to claim 7, the method comprising a solid material storage step, a depressurization step, and a produced gas purge step, wherein
the solid material storage step is a step of receiving the carbon produced by the thermal decomposition from the introduction port into the lock hopper,
the depressurization step is a step of discharging the produced gas from the lock hopper to the combustible gas discharge path in a state where the introduction port is shut off,
the produced gas purge step is a step of discharging the produced gas in the lock hopper to the combustible gas discharge path by supplying the non-combustible gas from the non-combustible gas supply path to the lock hopper after the depressurization step, and
the solid material dispensing step is executed after the produced gas purge step.

9. The method for operating a lock hopper according to claim 8, wherein
the combustible gas discharge path includes a produced gas path and a mixed gas path,
the produced gas path is a path for extracting the produced gas from the lock hopper,
the mixed gas path is a path for extracting the combustible gas and the non-combustible gas from the lock hopper,
the lock hopper is connected to a combustible gas supply path,
the method includes a produced gas recovery step,
the produced gas recovery step is a step of discharging the produced gas in the lock hopper to the produced gas path by supplying the hydrocarbon from the combustible gas supply path to the lock hopper, and is a step to be executed between the depressurization step and the produced gas purge step, and
the produced gas purge step is a step of discharging the hydrocarbon in the lock hopper to the mixed gas path.

10. The method for operating a lock hopper according to claim 8, wherein
the thermal decomposition of the hydrocarbon is performed in a state where a pressure of the hydrocarbon is higher than atmospheric pressure,
the lock hopper is connected to a combustible gas supply path,
the method includes a pressurization step,
the pressurization step is a step of pressurizing an inside of the lock hopper by supplying the hydrocarbon from the combustible gas supply path to the lock hopper, and
the solid material storage step is executed after the pressurization step.

11. The method for operating a lock hopper according to claim 2, wherein
the combustible gas supplied to the lock hopper is hydrocarbon,
a feedstock used by the combustible gas production system is hydrocarbon,
the combustible gas that is a production target by the combustible gas production system is hydrogen,
the solid movement step includes a solid material reception step,
the solid material reception step is a step of supplying a catalyst as the solid for thermally decomposing the hydrocarbon into hydrogen and carbon, from an outside of the combustible gas production system to the lock hopper through the introduction port, and
the oxygen purge step is a step of purging, from the lock hopper, oxygen having entered the lock hopper in the solid material reception step.

12. The method for operating a lock hopper according to claim 11, wherein
the lock hopper is connected to a combustible gas supply path,
the method includes a pressurization step and a solid material dispensing step,
the pressurization step is a step of pressurizing an inside of the lock hopper by supplying the hydrocarbon from the combustible gas supply path to the lock hopper,
the solid material dispensing step is a step of discharging the catalyst from the discharge port to supply the catalyst to a side close to a reactor for the thermal decomposition, and is a step to be executed after the pressurization step, and
a pressure in the reactor is higher than atmospheric pressure.

13. The method for operating a lock hopper according to claim 12, the method comprising
a depressurization step, wherein
the depressurization step is a step of discharging, from the combustible gas discharge path, a produced gas flowed into the lock hopper in the solid material dispensing step, and
the produced gas is a mixture gas of the hydrocarbon and hydrogen produced by thermal decomposition of the hydrocarbon.

14. The method for operating a lock hopper according to claim 13, the method comprising
a produced gas purge step, wherein
the produced gas purge step is a step of discharging the produced gas from the lock hopper to the combustible gas discharge path by supplying a non-combustible gas from the non-combustible gas supply path to the lock hopper while bringing the lock hopper and the combustible gas discharge path into a communication state after the depressurization step.

15. The method for operating a lock hopper according to claim 14, wherein
the combustible gas discharge path includes a produced gas path and a mixed gas path,
the produced gas path is a path for extracting the produced gas from the lock hopper,
the mixed gas path is a path for extracting the produced gas and the non-combustible gas from the lock hopper,
the depressurization step is a step of discharging the produced gas to the produced gas path,
the produced gas purge step is a step of discharging the produced gas from the lock hopper to the mixed gas path,
the lock hopper is connected to a combustible gas supply path,
the method includes a produced gas recovery step, and
the produced gas recovery step is a step of discharging the produced gas in the lock hopper to the produced gas path by supplying the hydrocarbon from the combustible gas supply path to the lock hopper, and is executed between the depressurization step and the produced gas purge step.

16. The method for operating a lock hopper according to claim 14, the method comprising a non-combustible gas discharge step, wherein
the non-combustible gas discharge step is a step of discharging the non-combustible gas from the lock hopper to the non-combustible gas discharge path after the produced gas purge step, and
the solid material reception step is executed after the non-combustible gas purge step.

17. The method for operating a lock hopper according to claim 3, wherein the combustible gas discharged from the lock hopper to the combustible gas discharge path is returned to a path for producing a production target gas in the combustible gas production system.

18. A solid movement device comprising a lock hopper, the lock hopper being utilized for moving a solid from either one of an inside of a combustible gas production system and an outside of the combustible gas production system to another one of the inside of the combustible gas production system and the outside of the combustible gas production system, wherein
the combustible gas production system is a system that produces a combustible gas,
the lock hopper is connected to a discharge path and a non-combustible gas supply path separately from an introduction port for the solid and a discharge port for the solid,
a combustible gas discharge path is a path through which a gas containing a combustible gas is discharged from the lock hopper, and
a non-combustible gas supply path is a path for supplying a non-combustible gas to the lock hopper.

19. The solid movement device according to claim 18, wherein
the discharge path includes a combustible gas discharge path and a non-combustible gas discharge path,
the combustible gas discharge path is a path through which a gas containing a combustible gas in the lock hopper is discharged, and
the non-combustible gas discharge path is a path through which a non-combustible gas in the lock hopper is released to atmosphere.

20. The solid movement device according to claim 19, wherein
the combustible gas discharge path includes a produced gas path and a mixed gas path,
the produced gas path is a path for extracting the combustible gas from the lock hopper, and
the mixed gas path is a path for extracting the combustible gas and the non-combustible gas from the lock hopper.

21. The solid movement device according to claim 18, wherein
the lock hopper is connected to a combustible gas supply path, and
the combustible gas supply path is a path for supplying a combustible gas to the lock hopper.
